(19) United States
(12) Patent Application Publication
(10) Pub. No.: US 2012/0112616 A1
(43) Pub. Date: May 10, 2012

(54) STRUCTURE OF HEAT DISSIPATING SHEET FOR PLASMA DISPLAY PANEL

(76) Inventor: Kun Young Kim, Daegu (KR)

(21) Appl. No.: 13/141,591

(22) PCT Filed: Nov. 3, 2009
(86) PCT No.: PCT/KR09/06416

§ 371 Date: Aug. 1, 2011

(30) Foreign Application Priority Data
Dec. 22, 2008 (KR) 10-2008-0130937

(51) Int. Cl. H01J 7/24

(52) U.S. Cl. 313/46

(57) ABSTRACT

Disclosed is a structure of a heat dissipating sheet for a plasma display panel. A heat dissipating sheet is interposed between a panel and a chassis base. Since the uppermost layer has a hollow structure with one or more hollow(s), the panel has a uniform temperature distribution and heat may be quickly dissipated from the panel.

### TECHNICAL FIELD

This disclosure relates to a plasma display panel (PDP), more particularly to a structure of a heat dissipating sheet for a plasma display panel wherein a hollow structure of the heat dissipating sheet is used to improved heat dissipation efficiency of the plasma display panel.

### BACKGROUND ART

A plasma display panel is a type of display device which exhibits luminance by generating a gas discharge inside cells. The plasma display panel is classified into an alternating current (AC) type and a direct current (DC) type in accordance with a discharge type. As the AC-type plasma display panel, an AC three-electrode surface discharge plasma display panel having three electrodes is widely used.

Recently, in response to increased demands on larger plasma display panels, the panel size is increasing consistently.

While the panel is operated, a lot of heat is generated in the panel due to gas discharge. Also, a relatively large amount of heat is generated in a printed circuit board for operating the panel. The amount of heat increases with the size of the panel. The heat often results in unstable panel operation and decreased life cycle. To solve this problem, a variety of heat dissipating means is employed in plasma display panels.

FIG. 1 exploded perspective view of a plasma display panel according to a prior art, and FIG. 2 is a cross-sectional view of the plasma display panel of FIG. 1.

As illustrated in FIG. 1 and FIG. 2, the plasma display panel 100 has a panel 10 for displaying an image. The panel 10 consists of a front panel 11 and a rear panel 13 which are sealed with each other. On the rear surface of the rear panel 13, a chassis base 30 for a heat dissipating sheet is fixed with a heat dissipating sheet 20 interposed between the panel 10 and the chassis base 30. The chassis base 30 is adhered to the rear panel 13 by means of an adhesive (not shown in the figure), e.g. a double-sided adhesive tape, provided along the front border of the chassis base 30. The chassis base 30 is commonly made of a 0.5-3.0 mm thick metal plate with good thermal conductivity (e.g. aluminum, galvalume, EGI, etc.). On the rear surface of the chassis base 30, a printed circuit board 40 for operating the panel is mounted by means of a coupling means (not shown in the figure).

While the plasma display panel 100 is operated, heat generated from the panel 10 due to a gas discharge is dissipated to outside through the heat dissipating sheet 20 and the chassis base 30.

However, in most cases, the heat generated from the panel 10 is not uniform on the surface of the panel 10. And, since the heat dissipating sheet 20 comprises a single-layered or multiple-layered thermally conductive sheet with uniform thickness and is adhered at the center of the whole rear surface of the rear panel 13, the heat generated from the panel 10 is not dissipated through the heat dissipating sheet 20 uniformly and quickly. As a result, internal temperature is not uniform during the operation of the plasma display panel and operation stability of the plasma display panel is not good because of relatively high temperature.

### DISCLOSURE OF INVENTION

### Technical Problem

Accordingly, this disclosure is directed to enabling a uniform dissipation of heat by providing a heat dissipating sheet with a hollow structure between a panel and a chassis base for a heat dissipating sheet.

The disclosure is also directed to enabling a fast dissipation of heat from a panel using a heat dissipating sheet with a hollow structure.

### Solution to Problem

In an aspect, there is provided a structure of a heat dissipating sheet for a plasma display panel, the plasma display panel including: a panel for displaying an image; a chassis base for a heat dissipating sheet fixed on a rear surface of the panel; a multi-layered heat dissipating sheet interposed between the panel and the chassis base; and a printed circuit board mounted on the rear surface of the chassis base to operate the panel, wherein the uppermost layer of the heat dissipating sheet which faces the chassis base has a hollow structure with one or more hollow(s).

The heat dissipating sheet may include a first layer which contacts the panel, and one or more heat conducting material layer(s) formed on the first layer.

The first layer may be an acryl-based or silicone-based polymer adhesive layer.

The heat conducting material layer may be formed of one or more material(s) selected from a group consisting of carbon, graphite, carbon nanotube (CNT), copper, aluminum, gold, silver, bronze, iron and zinc.

The heat conducting material layer may be a plurality of layers of materials having the same thermal conductivity.

Alternatively, the heat conducting material layer may be a plurality of layers of materials having different thermal conductivity.

The hollow structure may contact the whole front surface of the chassis base.

Alternatively, the hollow structure may be spaced apart from the front surface of the chassis base.

The hollow structure may be a single-layered hollow structure or a multi-layered hollow structure.

### Advantageous Effects of Invention

Since the uppermost layer of a heat dissipating sheet has a hollow structure with hollow(s), heat may be uniformly and quickly dissipated from a panel. Therefore, the heat dissipating sheet has improved heat dissipation efficiency and provides improved operation stability.

### BRIEF DESCRIPTION OF DRAWINGS

The above and other aspects, features and advantages of the disclosed exemplary embodiments will be more apparent from the following detailed description taken in conjunction with the accompanying drawings in which:

FIG. 1 is an exploded perspective view of a plasma display panel according to a prior art;

FIG. 2 is a cross-sectional view of the plasma display panel of FIG. 1;

FIG. 3 is a cross-sectional view of a structure of a heat dissipating sheet for a plasma display panel according to an embodiment of a present disclosure;

FIG. 4 is an enlarged cross-sectional view of the heat dissipating sheet of FIG. 3, showing a semi-circular multi-hollow structure of an uppermost layer and a projecting part of the multi-hollow structure in contact with the whole front surface of a chassis base;

FIG. 5 is an enlarged cross-sectional view of the heat dissipating sheet of FIG. 3, showing a multi-hollow structure with a quadrangular hollow of an uppermost layer and a projecting part of the multi-hollow structure in contact with the whole front surface of a chassis base;

FIG. 6 is an enlarged cross-sectional view of the heat dissipating sheet of FIG. 3, showing a semi-circular multi-hollow structure of an uppermost layer and a projecting part of the multi-hollow structure spaced apart from the front surface of a chassis base without contact;

FIG. 7 is an enlarged cross-sectional view of the heat dissipating sheet of FIG. 3, showing a single-layered hollow structure and a projecting part of the single-layered hollow structure in contact with the whole front surface of a chassis base; and

FIG. 8 is an enlarged cross-sectional view of the heat dissipating sheet of FIG. 3, showing a multi-layered hollow structure and a projecting part of the multi-layered hollow structure in contact with the whole front surface of a chassis base.

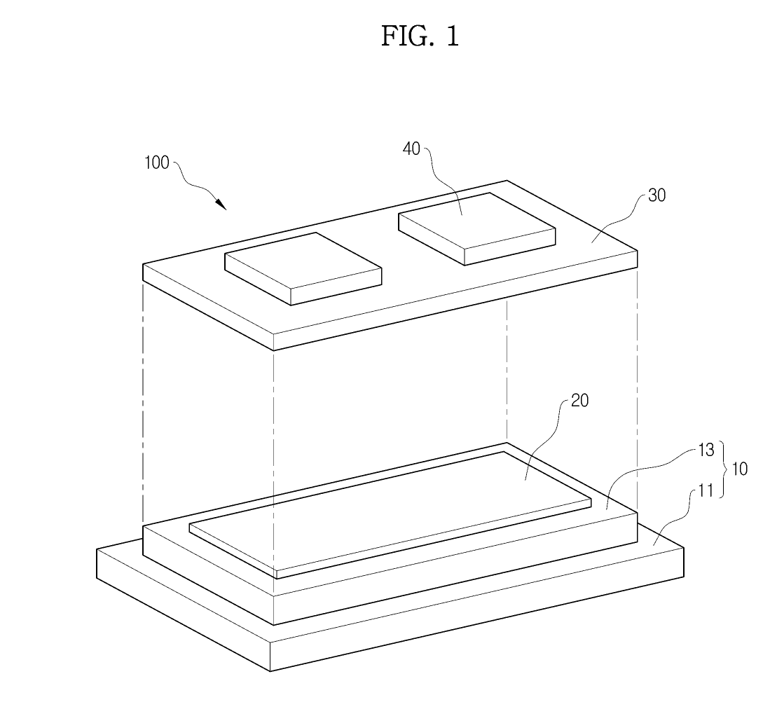

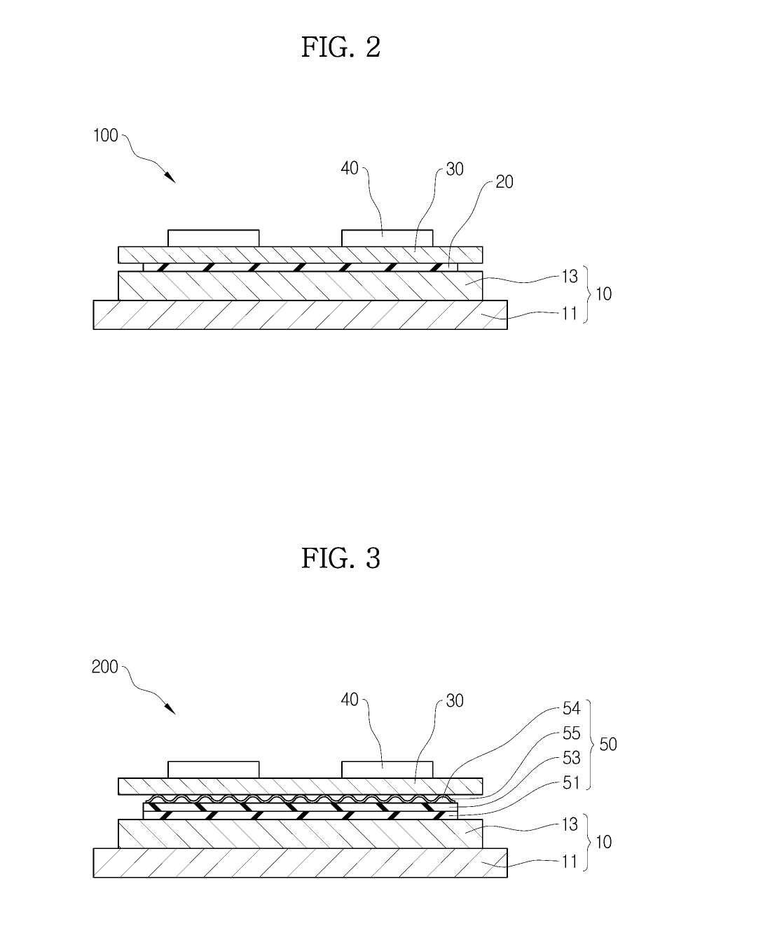

### Best Mode for Carrying out the Invention

Exemplary embodiments now will be described more fully hereinafter with reference to the accompanying drawings, in which exemplary embodiments are shown. This disclosure may, however, be embodied in many different forms and should not be construed as limited to the exemplary embodiments set forth therein. Rather, these exemplary embodiments are provided so that this disclosure will be thorough and complete, and will fully convey the scope of this disclosure to those skilled in the art. In the description, details of well-known features and techniques may be omitted to avoid unnecessarily obscuring the presented embodiments.

The terminology used herein is for the purpose of describing particular embodiments only and is not intended to be limiting of this disclosure. As used herein, the singular forms a, an and the are intended to include the plural forms as well, unless the context clearly indicates otherwise. Furthermore, the use of the terms a, an, etc. does not denote a limitation of quantity, but rather denotes the presence of at least one of the referenced item. The use of the terms first, second, and the like does not imply any particular order, but they are included to identify individual elements. Moreover, the use of the terms first, second, etc. does not denote any order or importance, but rather the terms first, second, etc. are used to distinguish one element from another. It will be further understood that the terms comprises and/or comprising, or includes and/or including when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

In the drawings, like reference numerals in the drawings denote like elements. The shape, size and regions, and the like, of the drawing may be exaggerated for clarity.

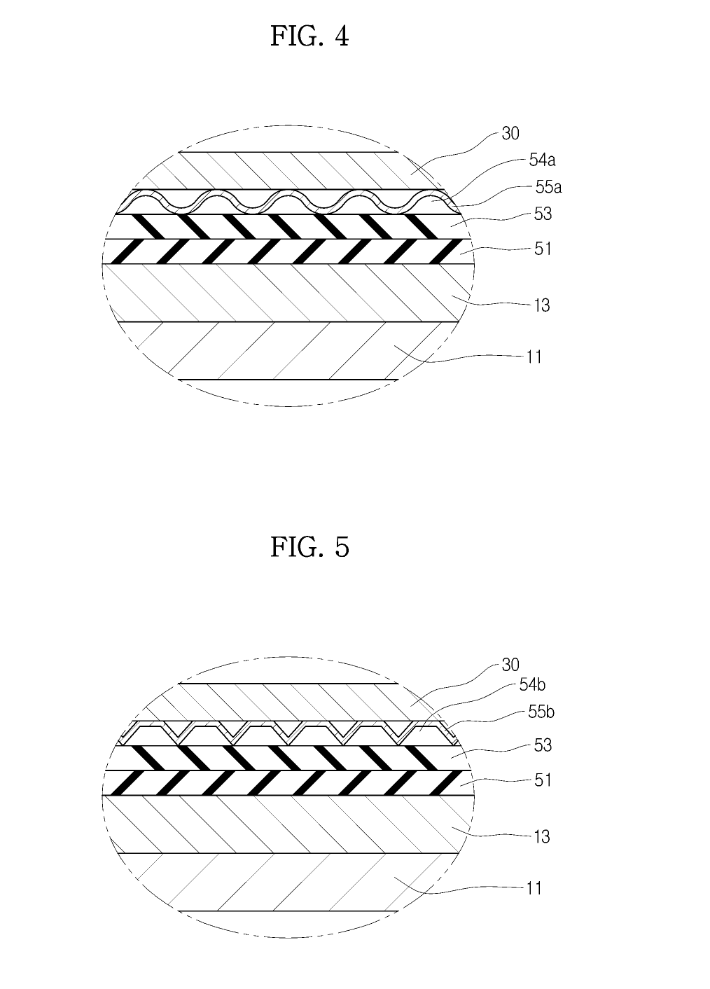

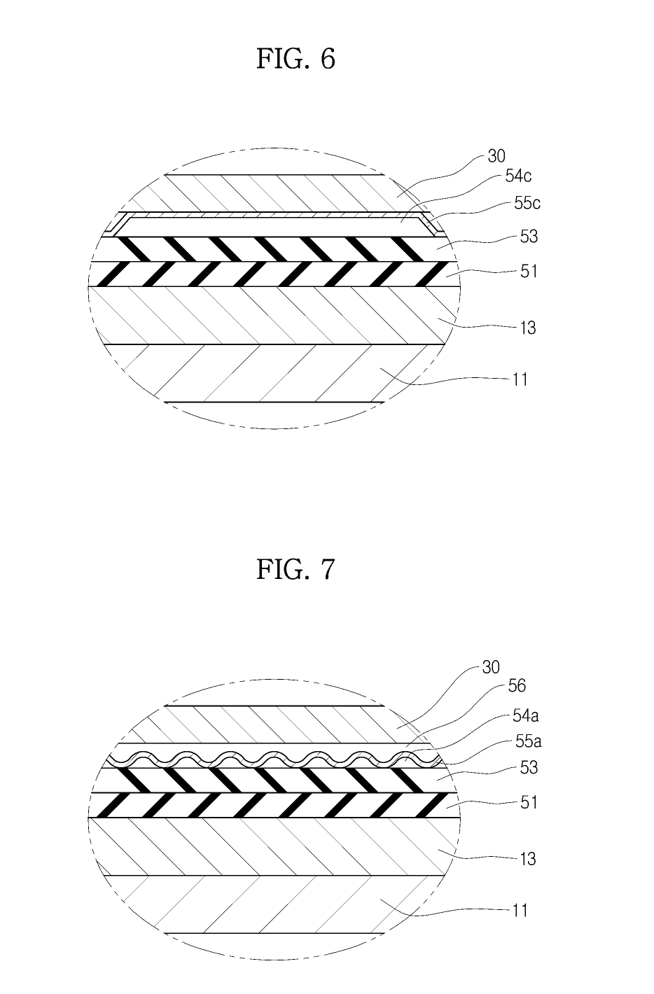

FIG. 3 is a cross-sectional view of a structure of a heat dissipating sheet for a plasma display panel according to an embodiment of a present disclosure. FIG. 4 is an enlarged cross-sectional view of the heat dissipating sheet of FIG. 3, showing a semi-circular multi-hollow structure of an uppermost layer and a projecting part of the multi-hollow structure in contact with the whole front surface of a chassis base. FIG. 5 is an enlarged cross-sectional view of the heat dissipating sheet of FIG. 3, showing a multi-hollow structure with a quadrangular hollow of an uppermost layer and a projecting part of the multi-hollow structure in contact with the whole front surface of a chassis base. And, FIG. 6 is an enlarged cross-sectional view of the heat dissipating sheet of FIG. 3, showing a semi-circular multi-hollow structure of an uppermost layer and a projecting part of the multi-hollow structure spaced apart from the front surface of a chassis base without contact. For convenience sake, description will be made referring to FIGS. 3 to 6 in association.

Referring to FIGS. 3 to 6, a plasma display panel 200 according to the disclosure comprises a panel 10 for displaying an image. The panel 10 comprises a front panel 11 and a rear panel 13 which are sealed with each other. On the rear surface of the rear panel 13, a chassis base 30 for a heat dissipating sheet is fixed with a heat dissipating sheet 50 interposed between the panel 10 and the chassis base 30. The chassis base 30 is adhered to the rear panel 13 by means of an adhesive (not shown in the figure), e.g. a double-sided adhesive tape, provided along the front border of the chassis base 30. The chassis base 30 is commonly made of a 0.5-3.0 mm thick metal plate with good thermal conductivity (e.g. aluminum, galvalume, EGI, etc.). On the rear surface of the chassis base 30, a printed circuit board 40 for operating the panel is mounted by means of a coupling means (not shown in the figure).

The heat dissipating sheet 50 may be provided on the whole or part of the rear surface of the rear panel 13. An uppermost layer of the heat dissipating sheet 50 may have a multi-layered structure, for example, a multi-layered structure with a first layer which contacts the panel 10 and one or more heat conducting material layer(s) formed on the first layer. The multi-layered structure may be formed of a first layer 51 which contacts the panel 10, and second and third layers 53, 55 sequentially formed on the first layer 51. To describe in more detail, the first layer 51 may be directly adhered at the center portion of the rear surface of the rear panel 13, and may be formed of an acryl-based or silicone-based polymer adhesive layer having a thermal conductivity.

The second layer 53 may be a heat conducting material layer having high thermal conductivity and may be formed on the first layer 51. It may be formed of one or more material(s) selected from a group consisting of carbon, graphite, carbon nanotube (CNT), copper, aluminum, gold, silver, bronze, iron and zinc.

The third layer 55 may be a heat conducting material layer having a hollow structure and having a thermal conductivity lower than that of the second layer 53 and may be formed on the second layer 53. It may be formed of one or more material(s) selected from a group consisting of carbon, graphite, CNT, copper, aluminum, gold, silver, bronze, iron and zinc.

The third layer 55 may have a hollow structure 55a with a plurality of hollows having a semi-circular 54a cross section, or a hollow structure 55b with a plurality of hollows having a quadrangular 54b cross section. All projecting parts of the hollow structure 55a and the hollow structure 55b may contact the whole front surface of the chassis base 30. Although not illustrated in the figure, the hollow structure may be formed of hollows with various cross-sectional shapes including oval, triangular, and the like, in addition to the semi-circular and quadrangular shapes. It may be formed by processing such as die casting, pressing, or the like.

Also, the projecting part of the hollow structure 55a may be spaced apart from the front surface of the chassis base 30 with a spacing 56, by controlling the thickness of a double-sided adhesive tape (not shown in the figure) which adheres the heat dissipating sheet 50 to the chassis base 30 along the border.

While the plasma display panel with such a structure is operated, heat generated from the panel 10 due to a gas discharge is dissipated to outside through the heat dissipating sheet 50 and the chassis base 30. Also, heat generated from the printed circuit board 40 is dissipated to outside through the chassis base 30.

Further, since the uppermost layer, i.e. the third layer 55, has a hollow structure, the third layer 55 has improved heat dissipation efficiency because of air flowing through the hollow, which results in increased heat dissipation efficiency of the heat dissipating sheet 50. As a result, the heat dissipating sheet 50 has significantly improved heat dissipation efficiency as compared to the existing heat dissipating sheet.

Accordingly, even when heat generation on the surface of the panel 10 is not uniform, the heat generated from the panel 10 may be quickly dissipated and the temperature distribution of the panel 10 may be maintained uniform because of the heat dissipating sheet 50 having the hollow structure. Furthermore, operation stability of the plasma display panel may be improved.

FIG. 7 is an enlarged cross-sectional view of the heat dissipating sheet of FIG. 3, showing a single-layered hollow structure and a projecting part of the single-layered hollow structure in contact with the whole front surface of a chassis base. Referring to FIG. 7, the heat dissipating sheet is similar to the multi-hollow structure of FIG. 4. Of course, a hollow structure 55c may be provided as spaced apart from the front surface of the chassis base, and the single-layered hollow structure may have hollows with various shapes. For convenience's sake, a detailed description about the hollow structure 55c will be omitted to avoid redundancy.

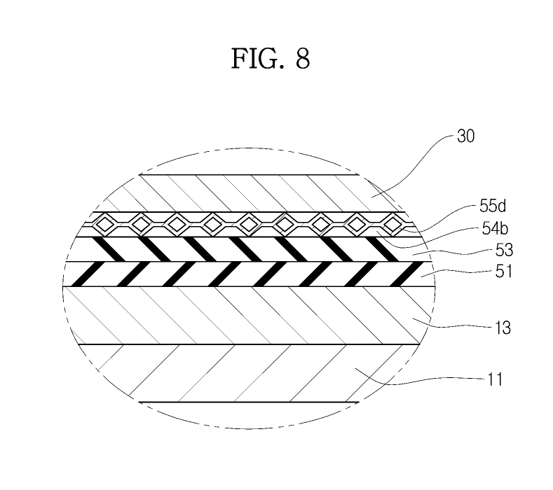

FIG. 8 is an enlarged cross-sectional view of the heat dissipating sheet of FIG. 3, showing a multi-layered structure and a projecting part of the multi-layered structure in contact with the whole front surface of a chassis base. Referring to FIG. 8, the heat dissipating sheet is similar to the multi-hollow structure of FIG. 5, except that a hollow structure 55d is a multi-layered hollow structure. Although the hollow structure 55d is depicted to have a two-layered structure, it may be formed of more layers. Of course, the hollow structure 55d may be provided as spaced apart from the front surface of the chassis base, and the multi-layered hollow structure may have hollows with various shapes. For convenience's sake, a detailed description about the hollow structure 55d will be omitted to avoid redundancy.

While the exemplary embodiments have been shown and described, it will be understood by those skilled in the art that various changes in form and details may be made thereto without departing from the spirit and scope of this disclosure as defined by the appended claims.

In addition, many modifications can be made to adapt a particular situation or material to the teachings of this disclosure without departing from the essential scope thereof. Therefore, it is intended that this disclosure not be limited to the particular exemplary embodiments disclosed as the best mode contemplated for carrying out this disclosure, but that this disclosure will include all embodiments falling within the scope of the appended claims.

1. A structure of a heat dissipating sheet for a plasma display panel, the plasma display panel comprising:
a panel for displaying an image;
a chassis base for a heat dissipating sheet fixed on a rear surface of the panel;
a multi-layered heat dissipating sheet interposed between the panel and the chassis base; and
a printed circuit board mounted on the rear surface of the chassis base to operate the panel,
wherein the uppermost layer of the heat dissipating sheet which faces the chassis base has a hollow structure with one or more hollow(s).

2. The structure of a heat dissipating sheet for a plasma display panel according to claim 1, wherein the heat dissipating sheet comprises a first layer which contacts the panel, and one or more heat conducting material layer(s) formed on the first layer.

3. The structure of a heat dissipating sheet for a plasma display panel according to claim 2, wherein the first layer is an acryl-based or silicone-based polymer adhesive layer.

4. The structure of a heat dissipating sheet for a plasma display panel according to claim 2, wherein the heat conducting material layer comprises one or more material(s) selected from a group consisting of carbon, graphite, carbon nanotube (CNT), copper, aluminum, gold, silver, bronze, iron and zinc.

5. The structure of a heat dissipating sheet for a plasma display panel according to claim 2, wherein the heat conducting material layer is a plurality of layers of materials having the same thermal conductivity.

6. The structure of a heat dissipating sheet for a plasma display panel according to claim 2, wherein the heat conducting material layer is a plurality of layers of materials having different thermal conductivity.

7. The structure of a heat dissipating sheet for a plasma display panel according to claim 1, wherein the hollow structure contacts the whole front surface of the chassis base.

8. The structure of a heat dissipating sheet for a plasma display panel according to claim 1, wherein the hollow structure is spaced apart from the front surface of the chassis base.

9. The structure of a heat dissipating sheet for a plasma display panel according to claim 1, wherein the hollow structure is a single-layered hollow structure or a multi-layered hollow structure.
